(19) United States
(12) Patent Application Publication
(10) Pub. No.: US 2006/0075157 A1
(43) Pub. Date: Apr. 6, 2006

(54) Programmable memory interfacing device for use in active memory management

(76) Inventor: Paul Marchal, Blanden (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/235,696

(22) Filed: Sep. 26, 2005

Related U.S. Application Data
(60) Provisional application No. 60/614,380, filed on Sep. 28, 2004.
(60) Provisional application No. 60/699,712, filed on Jul. 15, 2005.

(51) Int. Cl. G06F 13/28; G06F 12/00

(52) U.S. Cl. 710/22; 711/118

(57) ABSTRACT

An interface device for manipulating the data inside a memory or for assisting in manipulating the data between the memory and a nearby processor is disclosed. The device is a programmable core, having a limited instruction set designed for data layout transformations, pointer-chasing and data congregation/distribution. It is attached to the memory on which it performs data manipulations. One embodiment includes an interfacing device, comprising programmable hardware configured to handle information by providing burst type information transfers to assist data communication or access.

This patent application claims priority to U.S. 60/614380, titled “A Programmable Memory Interfacing Device for Use in Active Memory,” filed Sep. 28, 2004, and to U.S. 60/699712, titled “Method for Mapping Applications on a Platform/System,” filed Jul. 15, 2005, both of which are fully incorporated herein by reference.

### FIELD OF INVENTION

The invention relates to devices and method for improved memory management, especially suited for a multiprocessor environment, in particular in cases where data manipulation in one or more memories is dominant over the processor activities.

### BACKGROUND OF THE INVENTION

The performance of the cache influences to a large extent the performance and energy consumption of embedded systems. Cache provides fast and cheap (in terms of power) access to the data compared to the lower level memories (e.g., a L2-cache and/or main memory). It is able to do so by virtue of being closer to the processor and much smaller in size compared to lower level memories. Cache therefore allows considerable reduction in overall execution time and power consumption of embedded systems. For the cache to perform well, however, the program must exhibit high temporal and spatial locality. In general, array elements with nearby indexes tend to be accessed closer in time. This characteristic exhibited by ordinary programs is called spatial locality. Caches exploit this by loading a cache-line, i.e. a number of nearby memory locations whenever any one of those locations is accessed. Increasing the locality increases the amount of useful data pre-fetched by the cache and thus the system's performance. As a consequence, fewer cache-misses occur, reducing the average access latency and increasing the system's performance and decreasing its energy consumption.

In case of regular array accesses, loop transformations can be used to improve locality. However, there are three drawbacks to using loop transformations to influence spatial locality: loop transformations are constrained by data-dependencies; complex imperfectly nested loops pose a challenge for loop transformations; locality characteristics of all the arrays accessed in the nest are affected by them, some perhaps adversely.

Runtime data layout transformations are a complementary way for increasing the data locality. Usually, the layout of every array remains fixed throughout the entire duration of the program. We term this as a static data-layout. The layout of the individual arrays could be different within the same program. Note that with an m-dimensional array, m-factorial layouts are possible. If we include diagonal layouts, then many more combinations are possible. Whatever the layout for each of the arrays in the program, if they are all fixed for the entire duration of the program execution we still refer to it as static-layout. If the layout of an array is changed at run-time we term it as dynamic data-layout.
for(i= . . . )for(j= . . . )f1(a[i] [j] );
for(i= . . . )for(j= . . . )f2(a[j] [i] );

In the example above, the array is accessed in first line in row-major form. The same array further down in third line is accessed in column-major form. Assuming the array is so large that only a small part of it fits in the cache, spatial locality would play a big role in the cache performance of the above code. For high spatial reuse, the array must initially be stored in row-major form and then must be laid out as column-major for the third line.

Dynamic layout, as in example above, has its advantages and drawbacks. While it can be effective in increasing spatial locality once the layout has been changed to the locally optimal one, the re-mapping itself may need large amount of data transfers. That is, there is an overhead involved, which may actually increase the overall execution time and energy consumption. Currently, only processors can perform these layout transformations, but they are inefficient in terms of energy and performance for manipulating data. Therefore, runtime data layout transformations are not beneficial.

In case of irregular reads/writes to an array (e.g., A[B[i]]), limited spatial locality exist in the access pattern and usually many cache misses occur, thereby increasing the energy consumption. However, the access locality could be improved by congregating consecutive data elements that are accessed by the irregular array expressions. E.g. storing A[B[i]] A[B[i+1]] . . . A[B[i+n]] in an extra buffer Buff [ ] which the processor accesses Buff[0] Buff[1] . . . Buff[n]. Vice versa, after writing to Buff[ ], the data should be rerouted to their original positions. Unfortunately, only the processor can be currently instructed for congregating/distributing data, but is a poor data manipulator Besides, the congregation/distribution itself then pollutes the cache, thus causing many cache misses and increases the energy cost. As a result, this approach is in practice not applied.

Finally, limited data locality also exists during pointer-chasing. E.g., pointer-chasing occurs when dynamic memory managers look for free data blocks. It iterates over elements of a free list for finding the best data block. In this way, many data elements are touched and this again pollutes the cache and prevents the processor from executing useful instructions. As a result, again the performance degrades and energy consumption increases.

The above three problems can be overcome by manipulating the data with a special memory manipulator close to the memory in which the data resides.

In the high performance community, [D. Kim and M. Chauduri and M. Heinrich and E. Speight, “Architectural support for uniprocessor and multiprocessor active memory systems, IEEE trans. On computers, Vol. 18, no 3, March 2004, p 288-] has proposed to put an entire RISC processor next to the memory for manipulating the data layout. This approach is programmable and thus highly flexible, but it is not energy-efficient. On the other hand direct memory access controller such as on a (TI C6X) have been developed for transferring data between slow IO-devices and the memories. They can to some extent be used for manipulating data inside a memory. However, their instruction set is too limited for complex data-layout transformations. As a consequence, they require many instructions even for the simplest data layout transformation and can hardly operate independently from the processor. Moreover, pointer chasing or automatically congregating data for improving the cache misses are impossible to program on a DMA with the available instruction set. Hence, existing DMAs cannot efficiently solve the above three problems.

### Summary of the Certain Embodiments

To overcome the limitations of the DMA and the full blown co-processor, we propose a light-weight co-processor for manipulating the data inside the memory without accessing the communication architecture or cache memory. It is a programmable core. It has a limited instruction set designed for data layout transformations, pointer-chasing and data congregation/distribution (distribution is necessary when arrays are accessed with a irregular access pattern). It can operate in parallel of the processor cores. It is attached to next to the memories on which it performs data manipulations.

A system is presented, comprising a processor for data processing, a main memory, a cache memory, and a programmable memory interfacing device, coupled to said main memory and performing data layout changes in said main memory. Said data layout changes are performed to improve spatial locality in said memory for increasing the exploitation capacity of said cache memory. Alternatively instead of focusing on a hardware controlled cache, the interfacing device can also provide support on request of the processor to adequately transfer data to a so-called software controlled scratch pad memory. The ensemble of said main memory and said programmable memory interfacing device is denoted a DMA-capable memory.

Some embodiments can be situated now in a more general setting. Indeed some embodiments fit within a context wherein processor-processor, processor-memory or memory-to-memory communication or combinations thereof of data, instructions or combinations thereof, needs assistance from an extra hardware block, which is programmable, but has dedicated information (data and/or instruction) transfer capabilities to assist the communication context mentioned.

The communication assist device hence serves a role as programmable interfacing device, which is customized access controller, with particular information (data and/or instruction) handling capabilities.

The invented system (of FIG. 5) comprises of a plurality of nodes (10,15), which have either processing capabilities (e.g. a processor), storage capabilities (e.g. a memory (40)) or combinations thereof (e.g. a processor (20) with a local cache memory (30)) and at least one communication assist device (100), as discussed above, linked with said node, for data and/or instruction information transfer (200).

The communication assist device supports data manipulation towards storage means as requested by a processor, without the need that the processor has to handle said data manipulation itself.

This data manipulation support can be used to support more complex data manipulations which are required on a multiprocessor platform. Before a software application can be executed on such a multiprocessor platform, exploration of the data manipulation possibilities must be performed. Such exploration results in a selected data manipulation approach, which is selected in view of the performance (speed of the application execution) and cost (e.g power consumption cost of the multiprocessor platform). Techniques as described in U.S. Pat. No. 6,0699,712 can be used. The resulting data manipulation approach from such techniques, include block data transfers, which are supported by the devices claimed here.

### BRIEF DESCRIPTION OF THE DRAWINGS

FIG. 1 is a chart showing the total energy spent by the system for each version and each application. For Matrix-Addition we tried to improve spatial locality firstly by performing explicit copy (of array B from row-major to column-major). Even though during the addition phase spatial locality is good, the process of copying spends too much energy and so the overall performance is worse than the static-layout. Implementing the same layout change using DMA assistance gives a much better overall performance.

FIG. 2 is a chart comparing the price paid in energy for doing the explicit-copy itself. For each application we show in the second column the energy spent in just changing the layout. For a fair comparison its value is normalized with respect to the energy of running the original application (with static-layout). Comparing FIG. 1 and FIG. 2 it is clear that Matrix-Add and GameSound do not fare well with explicit-copy because it is far too expensive compared to the energy requirements of the whole application itself.

FIG. 3 is a chart showing the energy spent by different components of the system for each version of the Matrix-Add example. Because we use ARM7 core, the processor energy is high compared to the rest of the system. This undermines to some extent the significant gains on data cache and RAM. The increase in energy of explicit-copy comes from two sources, RAM and the core and to some extent the data and instruction cache. The DMA assist approach conserves the processor energy by using the DMA. The DMA itself, being a dedicated engine, uses negligible energy as seen in FIG. 3 .

FIG. 4 is a chart showing the overall execution time for each application. Note that in terms of both energy and execution time for the applications Matrix-Mult, 3D-Sound and Inverse by LU-D, explicit-copy is much better than static layout and only slightly worse than layout change using DMA-Capable Memories. This is so because of high reuse. In such cases, the benefits from layout improvement is so large that the cost of making the change is almost masked.

FIG. 5 is a block diagram showing the general setting of two data processing or storage nodes (10, 15) and an interfacing device (100), communicating (200) with said nodes. Also shown is some detail in one of the nodes, in particular a node comprises a processor (20) with a local memory (30), said local memory can be a cache or a scratch pad memory, while the other node is another memory (40).

FIG. 6 is a block diagram showing a multi-node (11,12) system, with multiple interfacing devices (101, 102), connected each to a node with a link (201, 202) and also to a general communication architecture (300) with a link (401,402).

FIG. 7 is a block diagram showing some detail of an embodiment of the interfacing device, in particular the presence of a control means (600), steering two parts of the interfacing device, each part handling information flow in one direction.

### DETAILED DESCRIPTION OF CERTAIN EMBODIMENTS

To overcome the limitations of the DMA and the full blown co-processor, we propose a light-weight co-processor for manipulating the data inside the memory without accessing the communication architecture or cache memory. It is a programmable core. It has a limited instruction set designed for data layout transformations, pointer-chasing and data congregation/distribution (distribution is necessary when arrays are accessed with an irregular access pattern). It can operate in parallel with the processor cores. It is attached next to the memories on which it performs data manipulations. E.g., it can transform an entire two-dimensional array from row-major to column major (and vice-versa), generating an interrupt once the transfer is complete. The processor can perform other tasks during the transfer.

With this approach data layout transformations, pointer-chasing and irregular array accesses can be performed more aggressively than before.

A system is presented, comprising a processor for data processing, a main memory, a cache memory, and a programmable memory interfacing device, coupled to said main memory and performing data layout changes in said main memory. Said data layout changes are performed to improve spatial locality in said memory for increasing the exploitation capacity of said cache memory. Alternatively instead of focusing on a hardware controlled cache, the interfacing device can also provide support on request of the processor to adequately transfer data to a so-called software controlled scratch pad memory. The ensemble of said main memory and said programmable memory interfacing device is denoted a DMA-capable memory.

One programmable memory interfacing device can be denoted a customized memory access controller (DMA), hence being programmable as a processor but still having the burst type data copying capability of classic DMA's. It can transfer a set of array elements from one location in said main memory to another.

As an embodiment an instruction may be provided which enables transforming an entire two-dimensional array from row-major to column major (and vice versa). It generates an interrupt once the transfer is complete.

As an embodiment an instruction may be provided which enables the interfacing device to provide dynamic memory management towards the processor.

The programmable memory interfacing device is programmable via a high-level API.

Some embodiments can be situated now in a more general setting. Indeed some embodiments fit within a context wherein processor-processor, processor-memory or memory-to-memory communication or combinations thereof of data, instructions or combinations thereof, needs assistance from an extra hardware block, which is programmable, but has dedicated information (data and/or instruction) transfer capabilities to assist the communication context mentioned.

The communication assist device hence serves a role as programmable interfacing device, which is customized access controller, with particular information (data and/or instruction) handling capabilities.

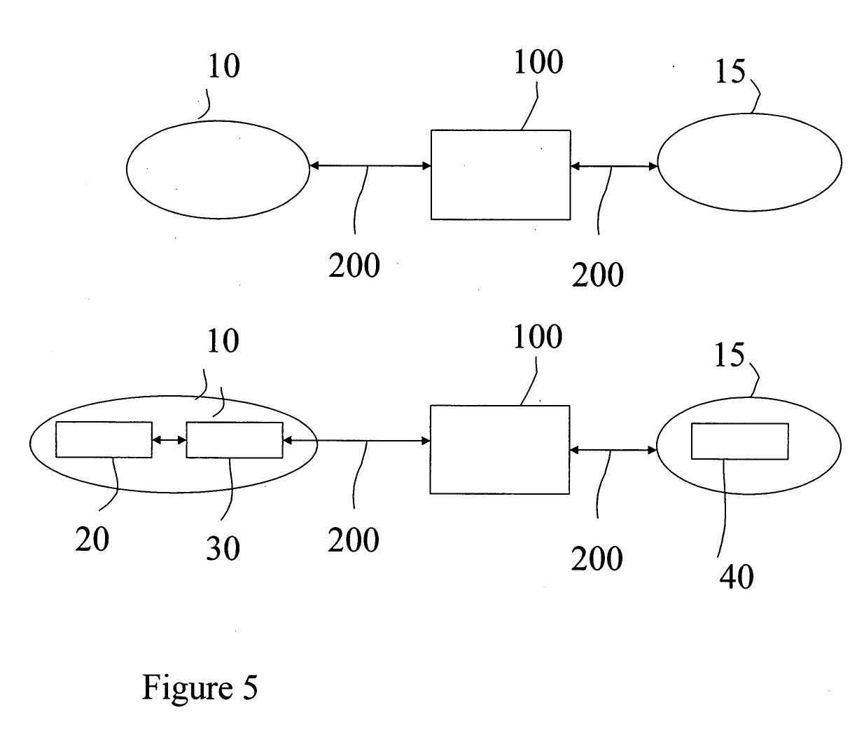

In one embodiment the system of FIG. 5 comprises a plurality of nodes (10,15), which have either processing capabilities (e.g. a processor), storage capabilities (e.g. a memory (40)) or combinations thereof (e.g. a processor (20) with a local cache memory (30)) and at least one communication assist device (100), as discussed above, linked with said node, for data and/or instruction information transfer (200).

The node may be connected directly via a local bus with the communication assist device.

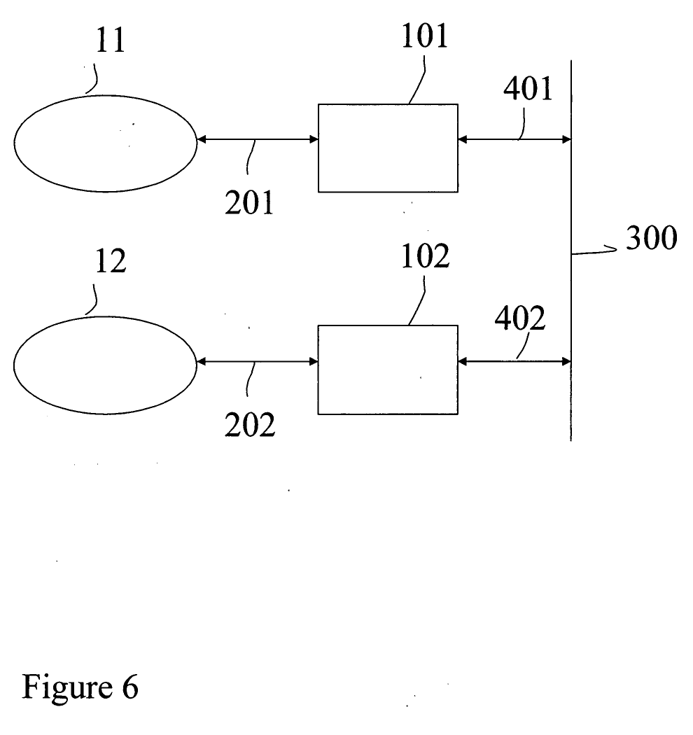

In an embodiment of the system as shown in FIG. 6 the system comprises of a plurality of nodes (11,12) and a plurality of communication assist devices (101,102), each node being connected directly via a local bus (201, 202) to its local communication assist. Further indirect links between the nodes are made by connecting each of the local communication assists to a communication architecture (300) with connection elements (401,402) (e.g with a pair of FIFO's), said communication architecture can be a bus and/or a network on chip. The above multi-node (e.g multiprocessor) system can be described as a system with distributed direct memory access facilities, enabling block transfer (using burst transfer is some embodiments) of data and/or instruction on said multi-node system.

The communication assist devices may need also some local memory for internal use. These can either be a part of the processor to which it is directly connected, or an own internal memory.

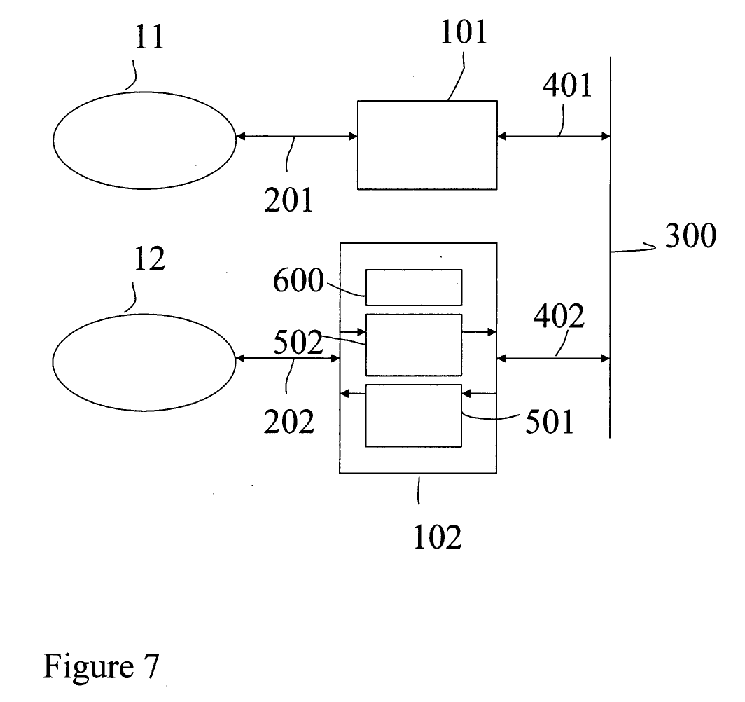

The communication assist device may as shown in FIG. 7 comprise of two DMA-engine like parts (501,502), each part handling one direction of the communication and a control element (600) for controlling said DMA-engine like parts, e.g. a microcontroller.

The communication assist device supports data manipulation towards storage elements as requested by a processor, without the need that the processor has to handle said data manipulation itself.

This data manipulation support can be used to support more complex data manipulations which are required on a multiprocessor platform. Before a software application can be executed on such a multiprocessor platform, exploration of the data manipulation possibilities must be performed. Such exploration results in a selected data manipulation approach, which is selected in view of the performance (speed of the application execution) and cost (e.g power consumption cost of the multiprocessor platform). Techniques as described in U.S. Pat. No. 6,0699,712 can be used. The resulting data manipulation approach from such techniques, include block data transfers, which are supported by the devices claimed here.

Experiments were performed on a SystemC-based cycle-accurate model of ARM multi-processor environment. The ARM processor has a local instruction cache (2 KB Direct Mapped) and a data cache (2 KB Direct Mapped). They are connected via the system bus (STBus) to the main memory (SDRAM). This memory has a DMA assist apparatus which can transfer a set of data from one location to another. It can also change the layout of the data (for example, from row-major to column major), during the copying.

In total experiments were performed with five applications. For some applications it was very clear from the high reuse-factor that changing layout would be beneficial. For others it depended on how much the layout change itself would cost. For these cases the DMA assist approach is superior to the existing art (explicit-copy).

Matrix Addition

This is a simple program where two N×N matrices A and B are combine to generate a third matrix C, such that C=A+BˆT. A and B are assumed to be stored originally in row-major format. If N×N is small enough so that A, B and C can all fit conveniently together in the cache, then no layout change is necessary. If fact, it would be an over-kill. We therefore set N×N to large enough 128×128. Matrix addition is a simple process with no reuse, i.e. each element is accessed only once, and so the question is whether it is still beneficial to do a layout transformation.

Matrix Multiplication

Two matrices A and B, each 50×50, are multiplied to generate a third matrix C=A×B.

Gaming Sound

In a typical PC or handheld game the user receives sounds from many directions to which he must react to protect himself. The sound reaching the user is delayed and attenuated depending on the distance and obstructions between the sound source and the user. The algorithm used mixes the different sounds reaching the hero with various attenuation and delays.

Sound-Spatialization

This application is within the domain of audio signal processing. In a typical movie-hall or the modern home-theater system, there are usually six to eight independent sources of sound (speakers) placed in various directions. The listener therefore gets to enjoy a 3-D audio field. When users are constrained to use headphones (as in an aircraft), the same impression of 3-D sound can be re-created by mixing the sounds from the six channels in a way that takes into account the human auditory system. The algorithm that used has a large set of coefficients which filter each of the sound inputs. There is high data reuse in this application.

Matrix Inversion by LU-Decomposition

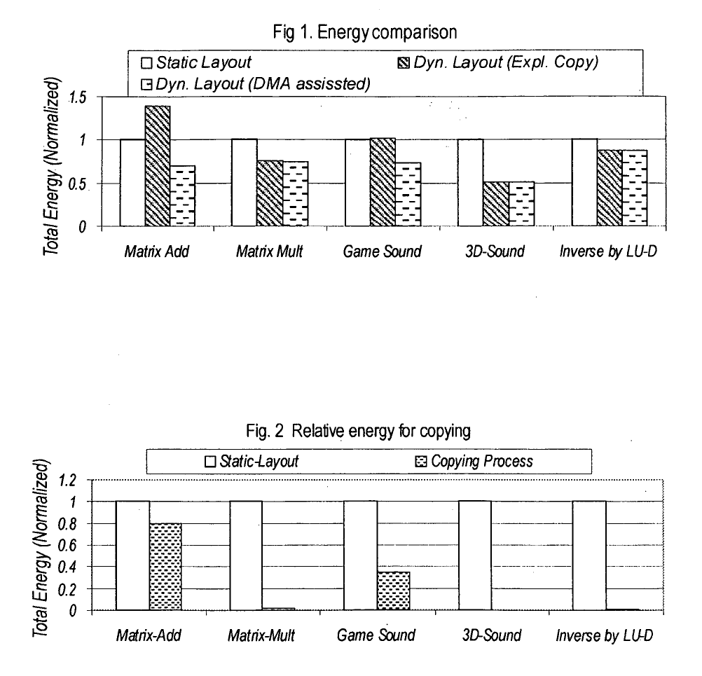

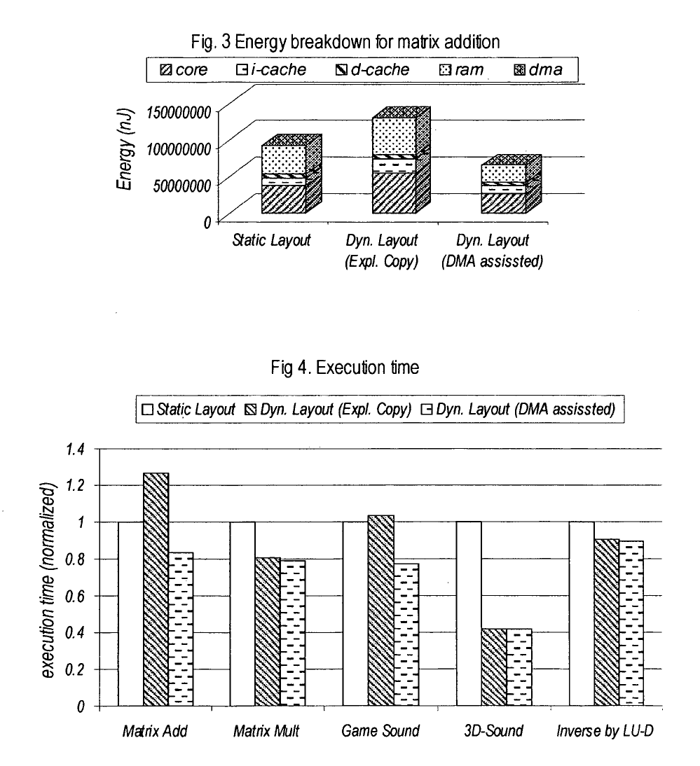

The results are discussed in FIG. 1 to 4.

What is claimed is:

1. An interfacing device, comprising programmable hardware configured to handle information by providing burst type information transfers to assist data communication or access.

2. The device of claim 1, wherein the programmable hardware is configured to assist in the transfer of data between a source and a destination, wherein the source and the destination each comprise at least one of a first memory, a second memory, a first processor and a second processor.

2. A data processing system, comprising:
a plurality of information processing or storage nodes; and
at least one interfacing device, comprising programmable hardware configured to handle information by providing burst type information transfers to assist data communication or access.

3. A data processing system as claimed in claim 2, wherein at least one of said nodes comprises:
a processor; and
first means for storing data connected to said processor, wherein said means for storing is connected to said at least one interfacing device.

4. A data processing system, as claimed in claim 3, wherein said means for storing acts as local cache for said processor.

5. A data processing system, as claimed in claim 4, further comprising at least one other node comprising a second means for storing data, wherein the at least one other node is connected to the interfacing device,. and said interfacing device is configured to perform data layout transformation within said second means for storing using burst type information transfer capabilities . . .

6. A data processing system, as claimed in claims 2, wherein said interfacing device comprises:
a first hardware portion configured to provideinformation handling in a first direction; and
a second hardware portionconfigured to provide information handling in a second direction, and a control element configured to control said first and second hardware portion.

7. A data processing system, as claimed in claim 6, wherein said means for controlling comprises a microcontroller.

8. A method for manipulating data in a data storage element as required by a processor, the method comprising:
providing instructions to a programmable interfacing device with said processor; and
performing data manipulation in the data storage element with said interfacing device.

9. The method of claim 8, wherein said data manipulation improves the performance of said processor in accessing data within the data storage element.

10. The method of claim 8, wherein said data manipulation improves the performance of said data storage element in accessing data of a cache memory connected to said processor.

11. The method of claim 8, wherein said data manipulation comprises a burst mode data transfer between said interfacing device and said data storage element.

12. The method of claim 11, wherein said data manipulation comprises performing data layout transformations within said data storage element.

13. A method of manufacturing a data processing system, the method comprising:
forming a plurality of information processing or storage nodes; and
forming at least one interfacing device, comprising programmable hardware configured to handle information by providing burst type information transfers to assist data communication or access.

14. The method of claim 13, wherein forming a plurality of information processing or storage nodes comprises:
forming a processor; and
forming first means for storing data connected to said processor, wherein said means for storing is connected to said at least one interfacing device.
